(19) United States
(12) Patent Application Publication
(10) Pub. No.: US 2009/0003152 A1
(43) Pub. Date: Jan. 1, 2009

(54) OPTICAL DISC APPARATUS, CONTROLLER OF OPTICAL DISC APPARATUS, AND CONTROL METHOD OF OPTICAL DISC APPARATUS

(75) Inventor: Akihiko Doi, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/146,220

(22) Filed: Jun. 25, 2008

(30) Foreign Application Priority Data
Jun. 29, 2007 (JP) 2007-173051

(51) Int. Cl. G11B 7/00

(52) U.S. Cl. 369/44.32; G9B/7

(57) ABSTRACT

According to one embodiment, an optical disc apparatus, includes an offset addition section configured to add an offset amount to the electric signal output from each of a photo receiving elements in accordance with a first signal, a gain variable section configured to adjust a gain amount of each offset added electric signal obtained by adding an offset in accordance with a second signal, an A/D converter configured to convert each of the offset added electric signals to a digital signal from an analog signal, a servo signal arithmetic section configured to generate an error signal used for focus and tracking servo control from the digital signal, a reference signal generation section configured to generate the first signal and the second signal from the digital signal, and a gain/offset correction section configured to correct the error signal in accordance with the first signal and the second signal.

### CROSS-REFERENCE TO RELATED APPLICATIONS

This application is based upon and claims the benefit of priority from Japanese Patent Application No. 2007-173051, filed Jun. 29, 2007, the entire contents of which are incorporated herein by reference.

### BACKGROUND

1. Field

One embodiment of the invention relates to an optical disc apparatus that adds an offset amount to a detection signal of a photo receiving element and also adjusts a gain, a controller for the optical disc apparatus, and a control method of the optical disc apparatus.

2. Description of the Related Art

In an optical disc apparatus, an offset amount is provided to a signal received by a pickup head, and a gain is adjusted.

For example, Jpn. Pat. Appln. Publication No. 2005-50434 discloses a configuration in which a direct current level of a signal detected at the time of mounting a disc is detected to set an offset amount, an error signal amplification for a servo is detected to set an adjustment value of a gain, and then a device is operated with setting values which are kept unchanged.

However, actual discs have various optical reflectivities, pregrooves and information pits of various sizes and various shapes, and have recording light amounts which are different depending on positions on the discs. Accordingly, repetition is changed depending on rotation, and an appropriate offset amount by moving in a radial position direction and an adjustment amount of a gain are changed.

### BRIEF DESCRIPTION OF THE SEVERAL VIEWS OF THE DRAWING

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a schematic configuration of an optical disc apparatus according to an embodiment of the present invention;

FIG. 2 is an exemplary plane view showing a configuration of an photodetector shown in FIG. 1;

FIG. 3 is an exemplary view showing a configuration for adjusting addition of an offset amount and a gain amount in a controller chip shown in FIG. 1;

FIG. 4 is an exemplary view showing an example of a waveform of each cell when focus tracking servo control is carried out;

FIG. 5 is an exemplary view showing examples of waveforms showing control with respect to changes in an offset and a gain in case a detection signal is reduced at the time of off-track due to change of a disc, and a correction method thereof;

FIG. 6 is an exemplary flowchart showing steps of control of addition of an offset amount and adjustment of a gain amount; and

FIG. 7 is an exemplary plane view showing the configuration of the photodetector shown in FIG. 1 as an example of a system different from FIG. 2.

### DETAILED DESCRIPTION

Various embodiments according to the invention will be described hereinafter with reference to the accompanying drawings. In general, according to one embodiment of the invention, an optical disc apparatus, comprises a divided photo receiving element including a plurality of photo receiving elements that detects light from an optical disc and converts the light to an electric signal, an offset addition section configured to add an offset amount to the electric signal output from each of the photo receiving elements in accordance with a first reference signal, a gain variable section configured to adjust a gain amount of each offset added electric signal obtained by adding an offset in accordance with a second reference signal, an A/D converter configured to convert each of the offset added electric signals to a digital signal from an analog signal, a servo signal arithmetic section configured to generate an error signal used for focus and tracking servo control from the digital signal output from the A/D converter, a reference signal generation section configured to generate the first reference signal and the second reference signal from the digital signal output from the A/D converter, and a gain/offset correction section configured to correct the error signal in accordance with the first reference signal and the second reference signal.

An embodiment of the present invention will be described hereinafter with reference to the accompanying drawings.

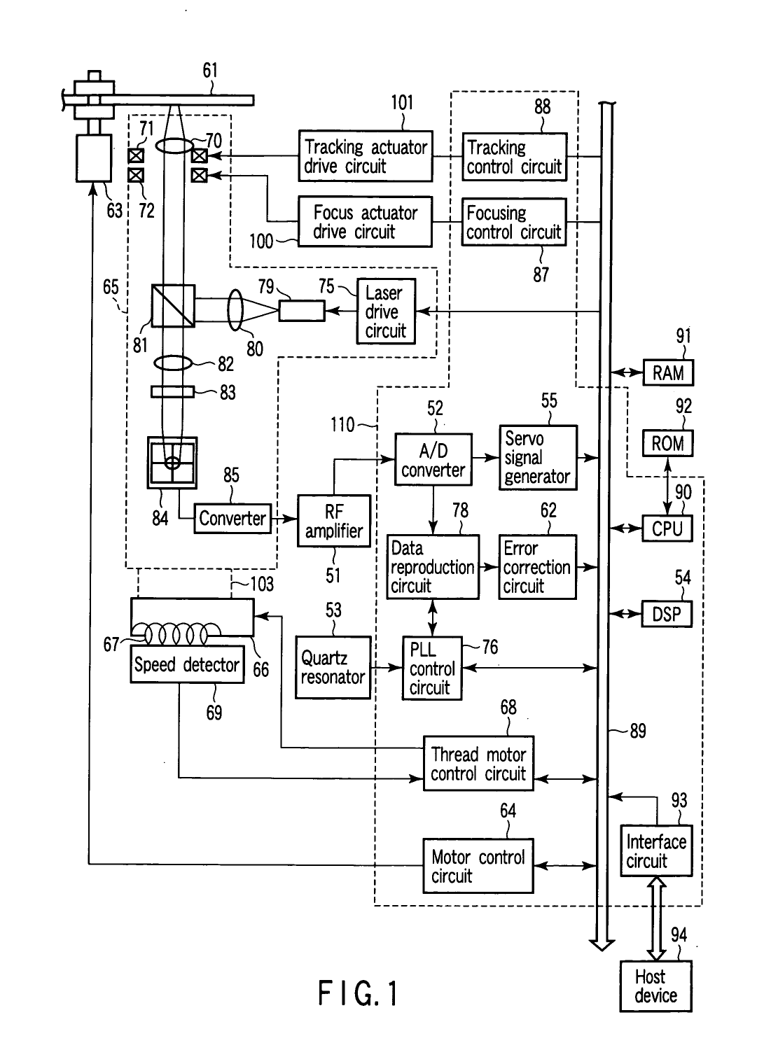

FIG. 1 is a block diagram showing a configuration of an optical disc apparatus according to the embodiment of the present invention.

An optical disc 61 set in an optical disc apparatus 11 is an optical disc that can record user data or an optical disc of read-only. In the present embodiment, the description will be made by assuming that the optical disc 61 is a recordable optical disc having a multi-layer structure. As an optical disc having information recording surfaces in a multi-layer structure, there are a DVD-R, and the like. However, the present invention is not limited thereto, and the optical disc 61 may be any optical disc which is capable of multi-layer recording.

Information recording surfaces of the optical disc 61 have a land track and a groove track formed thereon in a spiral manner. The optical disc 61 is driven by a spindle motor 63 in a rotational manner.

A pickup head 65 (a section enclosed by a broken line on a left side in FIG. 1) carries out recording and reproduction of information with respect to the optical disc 61. The pickup head 65 is connected to a thread motor 66 via a connection section 103 including a gear and the like. The thread motor 66 is controlled by a thread motor control circuit 68.

A speed detection circuit 69 positioned in a lower section of the thread motor 66 in FIG. 1 detects a moving speed of the pickup head 65, and is connected to the thread motor control circuit 68 described above. A speed signal of the pickup head 65 detected by the speed detection circuit 69 is sent to the thread motor control circuit 68. In addition, a permanent magnet (not shown) is provided at a fixed section of the thread motor 66. When a driving coil 67 is excited by the thread motor control circuit 68, the pickup head 65 is driven in a radial direction of the optical disc 61.

The pickup head 65 is provided with an objective lens 70 which is supported by a member (not shown) such as a wire and a plate spring. The objective lens 70 can move in a tracking direction (a direction orthogonal to an optical axis of the lens) when driven by a tracking drive coil 71. In addition, the objective lens 70 can move in the tracking direction (a direction orthogonal to an optical axis of the lens) and a focusing direction (an optical axis direction of the lens) when driven by a focusing drive coil 72.

When information is recorded in the optical disc 61, a modulation circuit 73 receives an information signal to be recorded from a host device 94 through an interface circuit 93 and a bus 89. Then, the modulation circuit 73 modulates the received information signal in accordance with a modulation system (for example, 8-16 modulation) specified in a standard of the optical disc 61. When information is recorded (a mark is formed) in the optical disc 61, a laser drive circuit 75 supplies a write signal to a semiconductor laser diode (laser oscillator) 79 on the basis of modulation data supplied from the modulation circuit 73. In addition, when information is reproduced, the laser drive circuit 75 supplies a readout signal which is smaller than the write signal to the semiconductor laser diode 79.

The semiconductor laser diode 79 generates laser light in accordance with the signal supplied from the laser drive circuit 75. The laser light emitted from the semiconductor laser diode 79 is irradiated on the optical disc 61 through a collimator lens 80, a half prism 81, and the objective lens 70. Reflected light from the optical disc 61 is guided to an photodetector 84 through the objective lens 70, the half prism 81, a condenser lens 82, and a hologram element 83. Here, the hologram element 83 is an element that can change a direction of transmitting light of a beam at each section. When the hologram element is used with the condenser lens 82, only light of a section which is desired to be cut out is gathered in a certain area on the photodetector.

The semiconductor laser diode 79 is made up of three semiconductor laser diodes that emit laser light for CD (infrared: a wavelength of 780 nm), for DVD (red: a wavelength of 650 nm), and for HDDVD (blue violet: a wavelength of 405 nm), respectively. These semiconductor laser diodes may be contained in the same CAN package. Alternatively, the semiconductor laser diodes may be contained in three independent CAN packages respectively, and allocated separately on a base of the pickup head 65. A configuration of and allocation in an optical system are changed as appropriate in accordance with a configuration of a semiconductor laser.

The objective lens 70 among members configuring the optical system is designed to be capable of converging laser light for HDDVD on a disc appropriately. In addition, the optical system includes an aberration correction element (a diffraction element, a phase correction element, and the like) for restricting aberration generated when laser light for DVD and laser light for CD are used, and a numerical aperture limiting element (a liquid crystal shutter, a diffraction element, and the like) for limiting a numerical aperture with respect to the objective lens when laser light for CD is used.

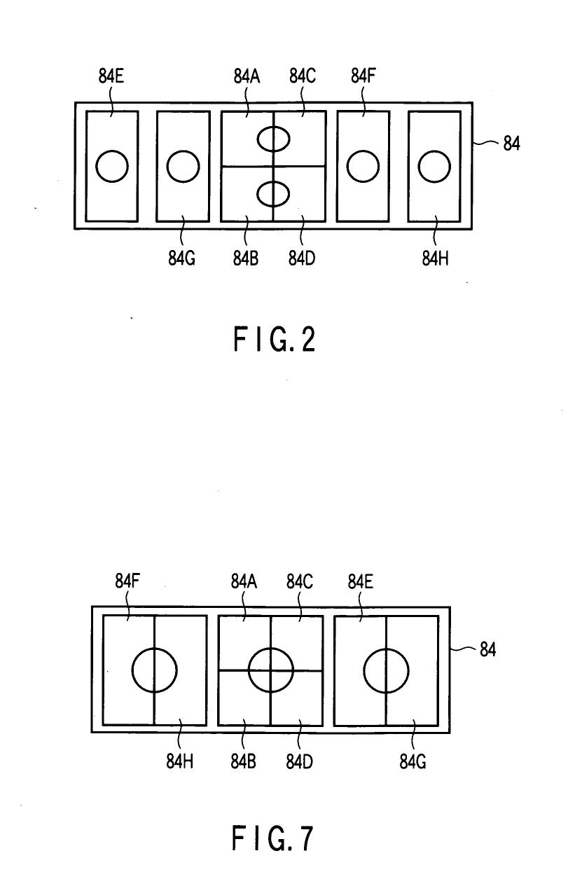

For example, as shown in FIG. 2, the photodetector 84 is configured with eight divided optical detection cells 84A to 84H. Each of the optical detection cells 84A to 84H outputs a signal of a current value corresponding to an optical intensity of received light.

Each of output signals of the optical detection cells 84A to 84H of the photodetector 84 is input to an RF amplifier 51 through a converter used for converting current and voltage. The RF amplifier 51 amplifies the output signals of the optical detection cells 84A to 84H. The amplified signals are converted to digital values by an A/D converter 52. A servo signal arithmetic section generates a focus error signal FE, a tracking error signal TE, an RF signal, and a wobble signal.

The focus error signal FE is a signal corresponding to (output of the optical detection cell 84A+output of the optical detection cell 84D)−(output of the optical detection cell 84B+output of the optical detection cell 84C). The focus error signal FE is supplied to a focusing control circuit 87. The circuit 87 supplies a drive signal corresponding to the focus error signal FE to a focus actuator drive circuit 100, and in this manner, laser light is controlled to be just focused on a recording surface of the optical disc 61 all the time.

The tracking error signal TE is a signal corresponding to (output of the optical detection cell 84E+output of the optical detection cell 84F)−(output of the optical detection cell 84G+output of the optical detection cell 84H). The tracking error signal TE is supplied to a tracking control circuit 88. Then, the tracking control circuit 88 generates a tracking drive signal in accordance with the tracking error signal TE. The tracking drive signal output from the tracking control circuit 88 is supplied to a tracking actuator drive circuit 101. The circuit 101 drives a tracking drive coil 71 that is driven in a direction orthogonal to an optical axis of the objective lens 70 in accordance with the tracking drive signal, and in this manner, control is carried out so as to have laser light irradiating on a predetermined location on a recording surface of the optical disc 61. In addition, the tracking error signal TE is also supplied to the thread motor control circuit 68.

The RF signal is a signal corresponding to (output of the optical detection cell 84A+output of the optical detection cell 84B+output of the optical detection cell 84C+output of the optical detection cell 84D). A phase locked loop (PLL) control circuit 76 extracts a clock signal reproducing clock signal supplied from a quartz resonator 53 from the RF signal. A data reproduction circuit 78 reproduces the RF signal based on a reproduction clock signal from the PLL control circuit 76, and generates a binarization signal.

The binarization signal is supplied to an error correction circuit 62. The error correction circuit 62 carries out error correction processing to convert the binarization signal to data of the original format before recording.

A DSP 54 passes a wobble signal through a band-pass filter provided therein having an appropriate range with respect to a center frequency depending on types of media. In this manner, the DSP 54 extracts a wobble component included in the wobble signal, and also applies FM demodulation processing to the wobble component. Then, from a result of the demodulation processing, the DSP 54 detects an absolute address on the optical disc 61 where a beam spot is positioned at this time, and sends out the absolute address to a CPU 90 as an address information signal.

The thread motor control circuit 68 controls the thread motor 66 to move a main body of the pickup head 65 so that the objective lens 70 is positioned in the vicinity of a center position in the pickup head 65.

In addition, the A/D converter 52, the data reproduction circuit 78, an error correction circuit 62, the PLL control circuit 76, the error correction circuit 62, the CPU 90, the DSP 54, the thread motor control circuit 68, a motor control circuit 64, the focusing control circuit 87, the tracking control circuit 88, and the like may be configured in one LSI chip. The CPU 90 controls the optical disc recording and reproducing device in an overall manner in accordance with an operation command supplied from the host device 94 through the interface circuit 93. In addition, the CPU 90 uses a RAM 91 as a work area, and carries out predetermined control in accordance with a program including processing according to the present embodiment recorded in a ROM 92.

The A/D converter 52, a servo signal arithmetic section 55, the data reproduction circuit 78, the PLL control circuit 76, the error correction circuit 62, the thread motor control circuit 68, the motor control circuit 64, the CPU 90, the DSP 54, the tracking control circuit 88, the focusing control circuit 87, and the interface circuit 93 are integrated in a controller chip 110.

The controller chip 110 of the optical disc apparatus according to the present embodiment has an offset adding function for adding an offset to output signals A to H of the optical detection cells 84A to 84H, respectively, and a gain variable function that can change a gain of the signals.

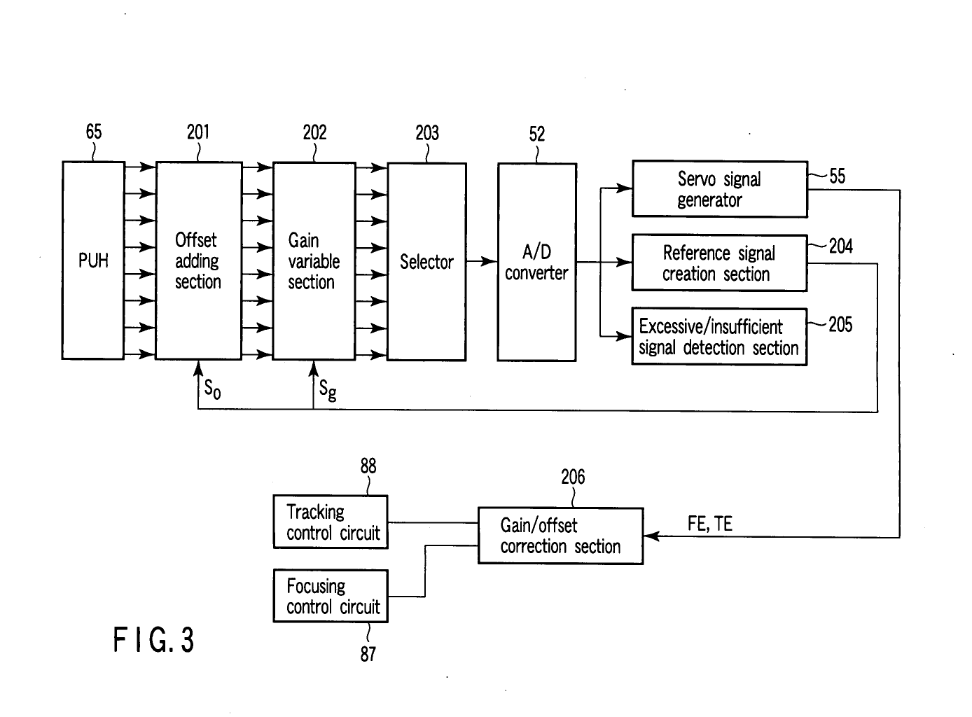

First, arithmetic calculation and a correction method of an offset and a gain at the time when a servo is actually carried out will be described with reference to FIG. 3.

Each of the output signals A to H of a pickup head 65 is input to an offset adding section 201. The offset adding section 201 adds an independent offset amount to each of the signals A to H. An output of the offset adding section is input to a gain variable section 202. The gain variable section 202 adjusts a gain of each of the signals. An output of the gain variable section 202 is input to a selector 203. The selector 203 outputs one of the input signals to the A/D converter 52. In principle, eight A/D convertors may be prepared. However, since an A/D convertor has high conversion speed in recent techniques, switching is generally made by using a switching signal as shown in the block diagram to carry out detection in a time sharing manner.

A signal from the pickup head 65 is converted to a digital signal at the A/D converter 52. Then, the servo signal arithmetic section 55 calculates the focus error signal FE=(A+D)−(B+C) and the tracking error signal TE=(E+F)−(G+H) described above.

A reference signal creation section 204 detects an average level of the signals A to H as a signal expressing an offset amount of the offset adding section 201. Then, the reference signal creation section 204 obtains an appropriate offset amount, with which the average level of the signals is at a middle point of a dynamic range of the A/D converter 52.

In addition, the reference signal creation section 204 calculates a sum signal of the four cells (A, B, C, and D) with respect to a focus as a signal expressing a gain amount of the gain variable section 202 with respect to a gain of each of the signals (A to D) for focusing. Then, the reference signal creation section 204 detects an average level of the signal. Then, the reference signal creation section 204 obtains an appropriate adjustment amount of a gain so that the average level is included in the dynamic range of the A/D converter 52.

In addition, the reference signal creation section 204 calculates a sum signal of the four cells (E, F, G, and H) with respect to tracking as a signal expressing a gain amount of the gain variable section 202 with respect to a gain of each of the signals (E to H) for tracking. Then, the reference signal creation section 204 detects an average level of the signal. Then, the reference signal creation section 204 obtains an appropriate adjustment amount of a gain so that the average level is included in the dynamic range of the A/D converter 52.

The reference signal creation section 204 is configured to feed back a signal So expressing an offset adding amount of each of the signals (A to H) and a signal Sg expressing a variable amount of a gain of each of the four cells for focusing and the four cells for tracking, obtained in the above manner.

As to a transmission method of the above signals, the adding amount of an offset and the variable amount of a gain may be transmitted directly by an analog voltage, and an adding circuit of a linear characteristic may be used as the offset adding section 201 and a gain control amplifier (a multiplying circuit) may be used as the gain variable section 202. However, in a method generally used in recent years, a digital signal is transmitted and processed by being applied with DA conversion (digital to analog conversion) in each function.

The error signals (servo signals) FE, TE, and the signals So and Sg expressing the adding amount of an offset and the variable amount of a gain obtained in the above manner are also transmitted to a gain/offset correction section 206 in a similar manner. This transmission may be carried out by using either an analog signal or a digital signal. The gain/offset correction section 206 removes an effect of an offset of each of the signals added in the offset adding section 201 and a gain varied in the gain variable section 202 previously from a servo signal after calculation. In this manner, the gain/offset correction section 206 creates an error signal for correct servo control. This operation will be described more in detail below.

When offsets of the signals obtained in the reference signal creation section 204 are A_{O} to H_{O}, a gain change amount of a focus signal is dF (a ratio to an appropriate value of the gain variable section 202), a gain change amount (a ratio to an appropriate value of the gain variable section 202) of tracking is dT, a suitability setting gain of a signal according to calculation of a focus error signal obtained in advance is Gt, and a suitability setting gain of a signal according to calculation of a tracking error signal is Gf, in order to make an output of the A/D converter 52 to be a center of operation, a value obtained by dividing the obtained offsets A_{O} to H_{O} by the gain change amount dF or dT is put into the offset adding section 201, and the gain variable section 202 changes the gains dF and dT. In the above case, the gain/offset correction section 206 subtracts the added offsets from each of the calculated error signals, and then divides the signals by the change amounts dF and dT provided for obtaining original gains. In this manner, correct servo control signals are obtained. The servo control signals are obtained as described below.

$$\begin{matrix}Obtained focus error signal = Gf \times \{ \begin{matrix}\begin{matrix}[ ( A + \frac{{A}_{O}}{dF} ) + ( D + \frac{{D}_{O}}{dF} ) ] - \\ [ ( B + \frac{{B}_{O}}{dF} ) + ( C + \frac{{C}_{O}}{dF} ) ] \times dF -\end{matrix} \\ [ ( {A}_{O} + {D}_{O} ) - ( {B}_{O} + {C}_{O} ) ]\end{matrix} \} \times \\ \frac{1}{dF} \\ = Gf \times [ ( A + D ) - ( B + C ) ] \\ = Original focus error signal\end{matrix}$$

In a similar manner:

$$\begin{matrix}Obtained focus error signal = Gt \times \{ \begin{matrix}\begin{matrix}[ ( E + \frac{{E}_{O}}{dT} ) + ( F + \frac{{F}_{O}}{dT} ) ] - \\ [ ( G + \frac{{G}_{O}}{dT} ) + ( H + \frac{{H}_{O}}{dT} ) ] \times dT -\end{matrix} \\ [ ( {E}_{O} + {F}_{O} ) - ( {G}_{O} + {H}_{O} ) ]\end{matrix} \} \times \\ \frac{1}{dT} \\ = Gt \times [ ( E + F ) - ( G + H ) ] \\ = Original focus error signal\end{matrix}$$

That is, an offset of each of the signals which is an appropriate value in an operation range of the A/D converter 52 is obtained and fed back, and even when a signal gain is corrected with a sum signal expressing each signal optical amount, a result obtained from the above calculation is equal to an error signal to be obtained. Accordingly, the above formulas express that a fluctuation of a disc can be tracked while maintaining an appropriate operation level of the A/D converter 52.

In case a fluctuation of a gain is small, there is a little effect to a dynamic range of the A/D converter 52. Accordingly, a gain is more easily changed in the gain/offset correction section 206 than in the gain variable section 202. However, in case of a fluctuation that is as large as having some effect, the gain variable section 202 needs to be switched. In actuality, different responses are made depending on fluctuation amounts of signals.

In addition, automatic tracking as described above is made responding in a substantially slow speed (approximately a speed less than 1/10) as compared with a fluctuation of a servo signal. As to an actual fluctuation, in case a disc is rotated in 16-time speed of DVD, a cycle of a fluctuation is one time per cycle, and a cycle is around 150 Hz, which is around 1/30 of a servo band that is around 5 kHz. Accordingly, tracking is sufficiently made.

Next, description will be made with respect to response in case a signal becomes significantly small due to a partial defect or the like, or a reflectivity of a medium is partially bright.

An excessive/insufficient signal detection section 205 detects a degree of change of a signal amount with respect to a signal detected at the A/D converter 52. In case a signal is not generated due to a scratch or dust of a large size, or, to the contrary, with respect to an area with an excessively high reflectively due to a partial defect of a reflection film on a disc, a sum signal of each of the focus tracking is detected, and then a comparator or the like detects rapid change which is above or below a certain value. In the above case, servo control should not be carried out with such a signal, and therefore, a servo control signal is held at a value immediately before the above detection. Then, this case is handled by returning to an original servo state when the above abnormal state is resolved, that is, signal amplitude returns to be appropriate. The above embodiment is described based on the premise that returning time is sufficiently short even when a circuit before the A/D converter 52 is saturated. However, in case saturation time is long, another sum signal with a significantly small gain may be generated separately, and detected at the A/D converter 52.

In addition, in case that a signal becomes small due to a fingerprint on a disc, or in case of a fluctuation that is generated by abnormality in a partial groove shape (for example, depth is partially different) and the like, the excessive/insufficient signal detection section 205 having a comparison voltage changed so as to be able to detect a rapid, but comparatively small fluctuation is prepared in advance in order to cope with the fingerprint problem. In this manner, discrimination can be made from the defect described above. After such discrimination is successively made, in this period, a gain is switched by increasing a speed of response to around two times (in case of a fingerprint, a gain generally becomes small to be around half). Then, feedback may be made. Similar operation is carried out when returning to a normal area from the above area.

Next, description will be made with respect to a case when large state change occurs, such as when information is recorded and reproduced.

In recent years, along the increase in the speed of disc rotation, detection of a servo signal while recording is generally carried out in a manner that an average value of a band of a signal waveform while recording, the band which is sufficiently faster than a servo band and sufficiently slower than a data band, is detected, and then third control is carried out. In this case, in case operation is transferred from reproduction to recording, or vice versa, a light-voltage conversion coefficient is first largely switched to obtain an output of a pickup signal almost equal to an output at the time of reproduction. Then, the gain variable section 202 at a later stage adjusts gain sections in detail, and switches to a correct signal gain (obtained in advance by learning or the like at the time of changing a disc) at the time of transferring operation. At this time, a necessary offset compensation value and the like which are obtained in advance are switched all at one when an operation mode is changed. Then, as described above, automatic tracking is carried out by using the offset adding section 201, the gain variable section 202, and the gain/offset correction section 206. As a matter of course, a similar operation is carried out when transfer is made from recording to reproduction.

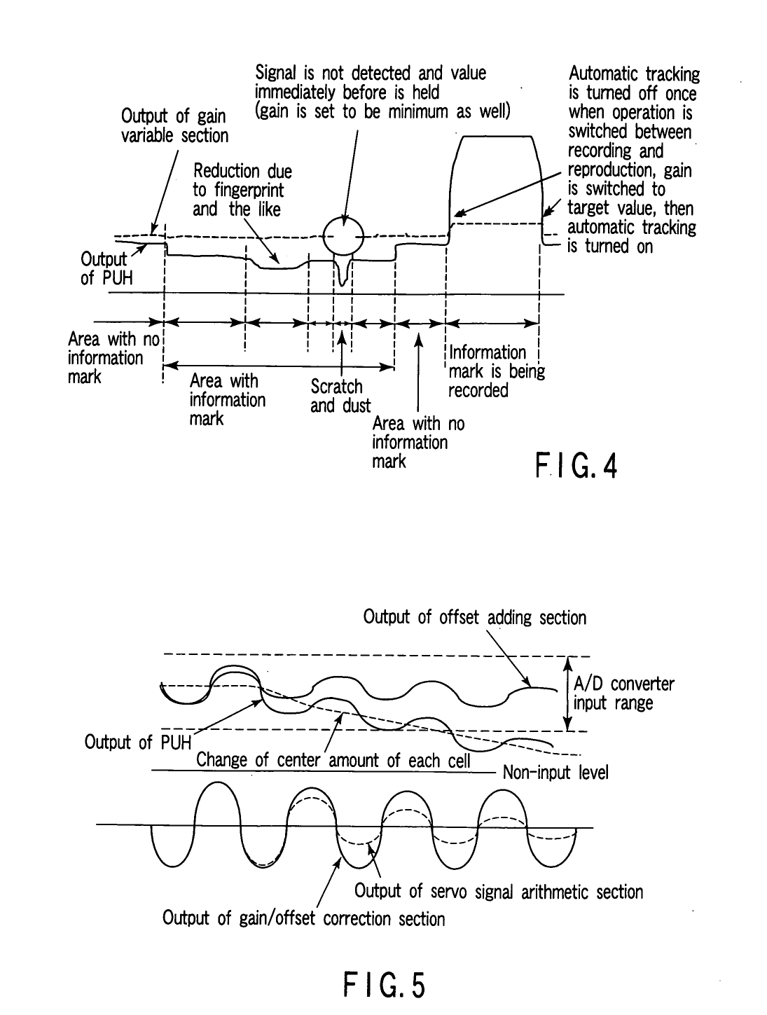

FIG. 4 shows a state of a signal of a gain and an offset at the time of tracking in case servos of focusing and tracking as described above are turned on. An output of an optical pickup and an output signal of a gain variable function are shown in response to a medium.

Reproduction is started from the left, which is an area with no information pit. Next, a fluctuation in an area with an information pit is expressed. A small fluctuation and a moderate fluctuation are tracked, while an output of the gain variable section 202 is not fluctuated by the tracking due to the principle described above. However, when there is a scratch, dust, and the like, a signal is lost rapidly. With respect to this section, a fluctuation is detected by the excessive/insufficient signal detection section 205 and an input signal is ignored. Next, an area with no information pit is reached, and this area is tracked in a manner similar as described above and almost the same level is maintained. Next, a recording area is reached. In this case, tracking is stopped once, and setting and the like, such as a target gain, a signal conversion gain of a pickup, and a center value of an offset voltage for correction are changed all at once. Therefore, although some offset error generated due to accuracy of setting and the like is generated, almost the same level can be maintained.

In case operation returns to reproduction, tracking is stopped once in a similar manner, and the setting is returned to the original state to carry out tracking again. So far, the description was made with respect to operation of reproduction and recording of data.

Next, description will be made with respect to access operation (in which an optical pickup is moved to a front position on a disc when target information data is reproduced or recorded) which is another operation mode of an optical disc. In this case, a focus is in a state of being controlled by a servo, and tracking is in a state where a servo is turned off. In this case, with respect to focusing, a servo is operated in a similar manner as described above. An error signal of tracking counts the number of lines changed while moving to detect a moving position and speed, and detects a timing of turning on a servo and the like from an output value immediately before a tracking servo. In such a case, tracking of an offset and a gain according to the embodiment of the present invention can be used for detection of a signal at the time tracking is turned off.

FIG. 5 describes an example of the signal in this case. As shown in this example, in case a pickup moves, a signal that changes for one cycle in one track appears in an output of the optical pickup. Changes are superposed here due to a difference between an area having an information mark and an area not having the information mark, a fluctuation in a reflectivity of a disc, and the like. Then, a change, such as that a signal amount is reduced depending on a position as shown in FIG. 5, is generated. At this time, for example, an average level is gradually reduced as shown in FIG. 5, and is out of an input range of the A/D converter 52 sooner or later. In addition, signal amplification that changes in a cycle of one track is also reduced depending on a state of a disc.

In view of the above, a gain/offset tracking function as described above is operated. In this case, as described above, a difference is not large when an average level is detected and changes in an offset and a gain are determined. However, in actuality, changes occur due to a state of a signal crossing a groove, in addition to a fluctuation in a light amount. Accordingly, an error is generated. In view of the above, signals of a peak level and a bottom level of fluctuations of each signal and a sum signal are detected, and for example, a middle level thereof is obtained by calculation. Then, by changing an offset and a gain on the basis of the middle level, detection can be carried out with high accuracy. In such a case, a tracking error signal obtained by calculation can be corrected so as to have amplification which is constant in comparison with a case where there is no processing carried out, as shown in the figure.

In addition, in case of a focus signal as well, since a signal crossing the groove leaks to an error signal, the focus signal is created from a signal obtained by detecting a peak and a bottom as similar to the case of tracking. In this manner, tracking with high accuracy becomes possible.

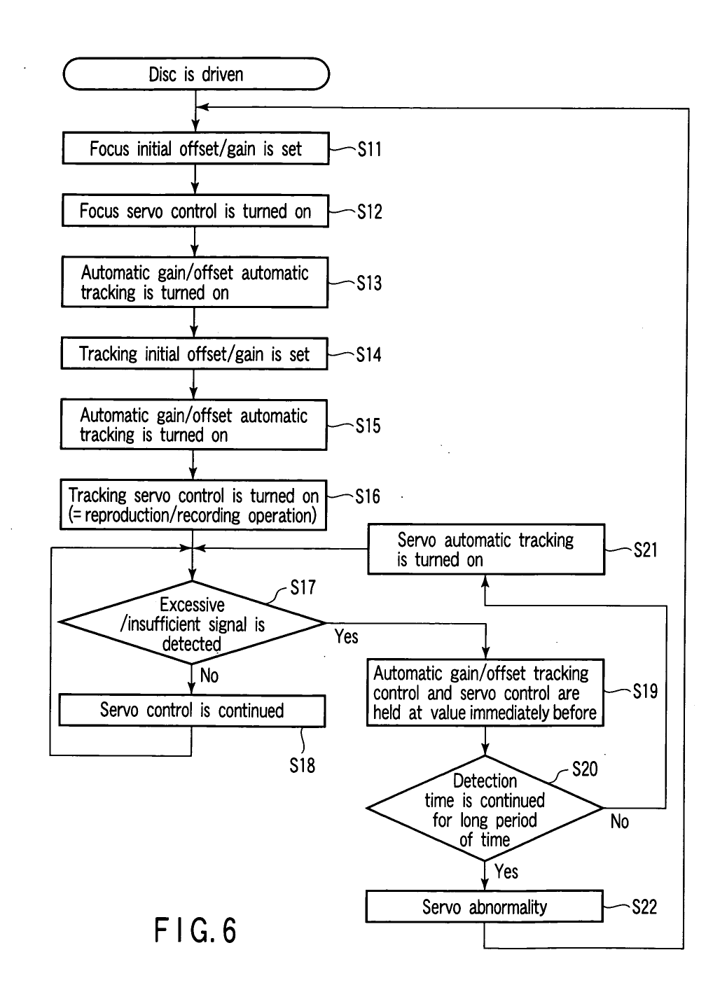

Operation is carried out in the above manner. Steps of actual control in an optical disc drive will be described with reference to a flowchart of FIG. 6.

First, when a disc is mounted, the objective lens 70 is first gradually changed to the front or to the back of an optimum point. In this manner, setting voltages of an offset and a gain are obtained, in which a center voltage of a change of an input voltage of the A/D converter 52 of each signal for focusing is positioned around operation of the A/D converter 52, and amplification of a focus error signal generated at the servo signal arithmetic section 55 matches with a target value (Step S11). Next, a focusing servo is turned on (Step S12), and then automatic tracking control as described above is turned on (Step S13).

Next, setting voltages of an offset and a gain are obtained, in which a center voltage of a change of an input voltage of the A/D converter 52 of each signal for tracking is positioned in a center of operation of the A/D converter 52, and amplification of a tracking error signal generated at the servo signal arithmetic section 55 matches with a target value (Step S14). Next, automatic tracking control is turned on (Step S15), and an effect to amplification due to a state of a disc is removed. Then, a tracking servo is turned on (Step S16).

After the above, access and the like are carried out to move to a target address, and reproduction and recording of information data are carried out. At this time, since the automatic offset/gain tracking control described above is turned on, correction is made with respect to a state of a disc. In this case, a defect is detected in the following manner. The excessive/insufficient signal detection section 205 has a threshold value that is used to detect a case when a change occurs with a value or a speed that exceeds a certain value or a certain speed. The excessive/insufficient signal detection section 205 detects a case in which a fluctuation amount of a level is larger than around ½, and such fluctuation has high speed (for example, equivalent to a servo band). Also, the excessive/insufficient signal detection section 205 detects a case when servo control cannot basically be carried out due to a local fluctuation of a reflectivity or due to a scratch or dust. In case there is not such detection (No in Step S17), servo control and an automatic tracking function of a gain and an offset are turned on all the time (Step S18). In case the above case is detected (Yes in Step S17), the automatic gain/offset tracking function is turned off (a value immediately before is held), and also servo control is held at a value immediately before (Step S19). Next, time is counted up until when a correct signal level, that is, a detection signal, is not detected from the above detection state. In case detection is made within a certain period of time or longer (for example, time that clearly makes out of range when a servo is turned on next time while a servo control is held, such as a period of time ten times as long as a servo band) (No in Step S20), the servo and the automatic tracking of a gain and an offset are turned on again (Step S21). In case the certain period of time is exceeded (Yes in Step S20), this case is considered as servo abnormality, and operation is repeated from the step of drawing the focus again (Step S22). At the time of this retry, values used in the first place in initial setting of an offset and a gain of a focus and tracking are memorized in advance, and such values may be set.

According to the present embodiment, even in case a fluctuation of a detection signal of a disc is large, A/D conversion in a state where accuracy of detection of each output signal of a pickup is excellent, and a signal gain can also be set with high accuracy. Accordingly, stable focusing and tracking servos with respect to changes in a reflectivity of a disc and a groove shape, and a defect on the disc can be embodied. In addition, even in case a track is monitored when an optical pickup crosses the track at the time of accessing, amplification of a tracking error signal can be detected with high accuracy regardless of changes of the disc as described above.

Next, an example of a detection system having a different detection and calculation method, as shown in FIG. 7 will be described. In case of this pickup head, calculation is carried out, in such a manner as the focus error signal FE described above=(A+D)−(B+C), and the tracking error signal TE=(A+B)−(C+D)−K·{(E+F)−(G+H)}. Here, K is a constant determined by the pickup. In this case, although the eight cells same as the pickup head described above are used, calculation is complicated. The calculation is such that a cell of the focus error signal and part of the cells of the tracking error signal, that is, A, B, C, and D, are superposed.

In such a case, correction of gains and offsets of A, B, C, and D is carried out, first for the focus error signal, in a manner similar to the one as described above.

Next, correction of gains and offsets of the remaining cells, E, F, G, and H, of the tracking error signal is carried out in a similar manner. Then, a result of calculation of the tracking error signal of an A/D converter is standardized and converted to Gt so as to obtain gains Gt of the remaining cells E, F, G, and H, since gains are A/D converted by using Gf with respect to calculation of A, B, C, and D. Then, reduction is carried out.

$$\begin{matrix}Obtained focus error signal = ( Gt / Gf ) \times Gf \times \\ \{ \begin{matrix}\begin{matrix}[ ( A + \frac{{A}_{O}}{dF} ) + ( D + \frac{{D}_{O}}{dF} ) ] - \\ [ ( B + \frac{{B}_{O}}{dF} ) + ( C + \frac{{C}_{O}}{dF} ) ] \times dF -\end{matrix} \\ [ ( {A}_{O} + {D}_{O} ) - ( {B}_{O} + {C}_{O} ) ]\end{matrix} \} \times \\ \frac{1}{dF} + K \times Gt \times \\ \{ \begin{matrix}\begin{matrix}[ ( E + \frac{{E}_{O}}{dT} ) + ( F + \frac{{F}_{O}}{dT} ) ] - \\ [ ( G + \frac{{G}_{O}}{dT} ) + ( H + \frac{{H}_{O}}{dT} ) ] \times dT -\end{matrix} \\ [ ( {E}_{O} + {F}_{O} ) - ( {G}_{O} + {H}_{O} ) ]\end{matrix} \} \times \frac{1}{dT} \\ = Gt \times [ ( A + D ) - ( B + C ) ] - K \times \\ [ ( {E}_{O} + {F}_{O} ) - ( {G}_{O} + {H}_{O} ) ] \\ = Original focus error signal\end{matrix}$$

The present invention can be applied to a system in which detection is carried out by superposed cells as described above.

The present invention is not limit to the above embodiments as they are, and can be embodied after constituents are modified in a range not deviating from a gist thereof in an implementing stage. In addition, a variety of inventions can be formed by properly combining a plurality of constituents disclosed in the above embodiments. For example, several constituents may be omitted from all constituents shown in the embodiments. Further, constituents extending to different embodiments may be properly combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus, comprising:
a divided photo receiving element including a plurality of photo receiving elements that detects light from an optical disc and converts the light to an electric signal;
an offset addition section configured to add an offset amount to the electric signal output from each of the photo receiving elements in accordance with a first reference signal;
a gain variable section configured to adjust a gain amount of each offset added electric signal obtained by adding an offset in accordance with a second reference signal;
an A/D converter configured to convert each of the offset added electric signals to a digital signal from an analog signal;
a servo signal arithmetic section configured to generate an error signal used for focus and tracking servo control from the digital signal output from the A/D converter;
a reference signal generation section configured to generate the first reference signal and the second reference signal from the digital signal output from the A/D converter; and
a gain/offset correction section configured to correct the error signal in accordance with the first reference signal and the second reference signal.

2. The optical disc apparatus according to claim 1, wherein the first reference signal is generated based on an average value of each of the photo receiving elements calculated with a long period of time with respect to a servo band of the error signal.

3. The optical disc apparatus according to claim 1, wherein the gain/offset correction section adds an optimum offset value to a characteristic of the optical disc to a value obtained by subtracting a total amount of an offset amount of each signal added at the offset addition section from the error signal.

4. The optical disc apparatus according to claim 1, wherein the second reference signal is generated based on an average value of an additional signal of the photo receiving elements according to the error signal calculated with a long period of time with respect to a servo band of the error signal.

5. The optical disc apparatus according to claim 1, wherein the gain/offset correction section corrects a gain amount of the error signal to be constant on the basis of a gain amount adjusted at the gain variable section.

6. The optical disc apparatus according to claim 1, wherein the first reference signal and the second reference signal are generated based on a signal obtained by calculation using two signals, which are a peak level and a bottom level of the error signal detected with a speed sufficiently slow with respect to a servo band.

7. The optical disc apparatus according to claim 1, further comprising an excessive/insufficient signal detection section configured to detect whether a digital signal output from the A/D converter has changed rapidly, wherein
an adjusting amount of a gain at the gain variable section is set to be a value determined in advance in a period that the excessive/insufficient signal detection section detects the rapid change.

8. The optical disc apparatus according to claim 1, wherein
the gain variable section adjusts a gain amount based on an amount determined in advance immediately before the transition, and then adjusts a gain amount based on the second reference signal generated from a digital signal output from the A/D converter after the transition, in case of transition from reproduction to recording of information or from recording to reproduction of information.

9. A controller of an optical disc apparatus, comprising:
an offset addition section that adds an offset amount according to a first reference signal to each electric signal output from a divided photo receiving element including a plurality of photo receiving elements that detects light from an optical disc and converts the light to an electric signal;
a gain variable section that adjusts a gain amount of each offset added electric signal obtained by adding an offset in accordance with a second reference signal;
an A/D converter that converts each of the offset added electric signals to be a digital signal from an analog signal;
a servo signal arithmetic section that generates an error signal used for focus and tracking servo control from a digital signal output from the A/D converter;
a reference signal generation section that generates the first reference signal and the second reference signal from the digital signal output from the A/D converter; and
a gain/offset correction section that corrects the error signal in accordance with the first reference signal and the second reference signal.

10. The controller of an optical disc apparatus according to claim 9, wherein the first reference signal is generated based on an average value of each of the photo receiving elements calculated with a long period of time with respect to a servo band of the error signal.

11. The controller of an optical disc apparatus according to claim 9, wherein the gain/offset correction section adds an offset value optimum to a characteristic of the optical disc to a value obtained by subtracting a total amount of an offset amount of each signal added at the offset addition section from the error signal.

12. The controller of an optical disc apparatus according to claim 9, wherein the second reference signal is generated based on an average value of an additional signal of the photo receiving element according to the error signal calculated with a long period of time with respect to a servo band of the error signal.

13. The controller of an optical disc apparatus according to claim 9, wherein the gain/offset correction section corrects a gain amount of the error signal to be constant on the basis of a gain amount adjusted at the gain variable section.

14. The controller of an optical disc apparatus according to claim 9, wherein the first reference signal and the second reference signal are generated based on a signal obtained by calculation using two signals, which are a peak level and a bottom level of the error signal detected with a speed sufficiently slow with respect to a servo band.

15. The controller of an optical disc apparatus according to claim 9, further comprising an excessive/insufficient signal detection section that detects whether a digital signal output from the A/D converter has changed rapidly, wherein
an adjusting amount of a gain at the gain variable section is set to be a value determined in advance in a period that the excessive/insufficient signal detection section detects the rapid change.

16. The controller of an optical disc apparatus according to claim 9, wherein
in case of transition from reproduction to recording of information or from recording to reproduction of information, the gain variable section adjusts a gain amount based on an amount determined in advance immediately before the transition, and then adjusts a gain amount based on the second reference signal generated from a digital signal output from the A/D converter after the transition.

17. A control method of an optical disc apparatus, comprising:
outputting an electric signal according to light received by each of a plurality of photo receiving elements included in a divided photo receiving element, the plurality of photo receiving elements detecting light from an optical disc and converting the light to an electric signal;
adding an offset amount to the electric signal output from each of the photo receiving elements in accordance with a first reference signal;
adjusting a gain of each offset added electric signal obtained by adding an offset in accordance with a second reference signal;
converting each of the offset added electric signals to be a digital signal from an analog signal;
generating an error signal used for focus and tracking servo control from a digital signal output from the A/D converter;
generating the first reference signal and the second reference signal from the digital signal; and
correcting the error signal in accordance with the first reference signal and the second reference signal.
